(19) United States
(12) Patent Application Publication
(10) Pub. No.: US 2013/0054710 A1
(43) Pub. Date: Feb. 28, 2013

(54) CATEGORIZING EMAIL RECIPIENTS INTO LOGICAL GROUPS WHEN SENDING A MASS EMAIL

(71) Applicants: ALAA H. ABOU MAHMOUD, DRACUT, MA (US); NANCY E. KHO, BELMONT, MA (US); BILL D. LE, REVERE, MA (US); FANG LU, BILLERICA, MA (US)

(72) Inventors: ALAA H. ABOU MAHMOUD, DRACUT, MA (US); NANCY E. KHO, BELMONT, MA (US); BILL D. LE, REVERE, MA (US); FANG LU, BILLERICA, MA (US)

(73) Assignee: INTERNATIONAL BUSINESS MACHINES CORPORATION, ARMONK, NY (US)

(21) Appl. No.: 13/222,406

(22) Filed: Aug. 31, 2011

(51) Int. Cl. G06F 15/16

(52) U.S. Cl. 709/206

(57) ABSTRACT

Receiving from an email sender a plurality of recipient identifiers corresponding to recipients to whom the email is to be sent. The recipient identifiers can be grouped into a plurality of groups. A respective version of the email can be generated for each of the groups of recipient identifiers, wherein each version of the email exclusively identifies as recipients recipient identifiers for a respective group of recipients. Each version of the email can be sent to the group of recipients for whom the version of the email is generated.

### BACKGROUND

One or more embodiments disclosed within this specification relate to the sending of mass electronic mails (emails).

With the proliferation of Internet access in recent decades, the use of email to exchange digital messages from an author to one or more recipients has become commonplace. Emails typically are communicated across the Internet or other computer networks. Email systems generally are based on a store-and-forward model in which emails are stored in an email client and/or email server and forwarded to one or more recipients. In this regard, email servers generally are configured to accept, forward, deliver and store email messages.

Email clients commonly are used to generate, send, forward and receive emails. The email clients may reside on a user's communication device (e.g., workstation, personal computer, mobile computer, tablet computer, personal digital assistant, mobile telephone, etc.), or on a server to which the user's communication device is communicatively linked. Via an email client, the user may generate an email, and identify one or more recipients to whom the email may be sent. The email recipients can include those who are identified in a “To” field, those identified in a “Cc” field, and those identified in a “Bcc” filed. “Cc” is an acronym for the term “carbon copy” and “Bcc” is an acronym for the term “blind carbon copy.” “Carbon copy” and “blind carbon copy” are legacy terms from when carbon paper commonly was used to produce one or more copies simultaneously during the creation of paper. Such terms have been carried over to modern electronic communication systems, even though electronic communication systems do not rely on carbon paper to create copies.

The recipients identified in the “To” field usually are the recipients to whom the content of the email is directed. The recipients in the “Cc” field usually are those recipients to whom the content is not specifically directed, but who are to be made aware of the email content. Those recipients identified in the “To” and “Cc” fields typically are identified in emails that are sent. Thus, all recipients receiving an email usually will be made aware of each of the recipients identified in the “To” field and the “Cc” field.

The recipients in the “Bcc” field usually are those recipients to whom the content of the email is not specifically directed, who are to be made aware of the email content, but whom the sender of the email wishes to remain unidentified in the emails sent to other recipients. Thus, recipients of emails typically are not made aware of other recipients who are identified in the “Bcc” field.

When sending an email to a large group of recipients, such as an email about a free concert, free ice cream, an upcoming movie, etc., the sender sometimes will list all of the recipients in the “Bcc” field of the email. Accordingly, the email does not provide to the recipients an indication of other recipients who received the email.

### BRIEF SUMMARY

One or more embodiments disclosed within this specification relate to categorizing email recipients into logical groups when sending a mass email. An embodiment can include receiving from an email sender a plurality of recipient identifiers corresponding to recipients to whom the email is to be sent. The recipient identifiers can be grouped into a plurality of groups. A respective version of the email can be generated for each of the groups of recipient identifiers, wherein each version of the email exclusively identifies as recipients recipient identifiers for a respective group of recipients. Each version of the email can be sent to the group of recipients for whom the version of the email is generated.

Another embodiment of the present invention relates to a system comprising a computer-readable storage medium having computer-readable program code embodied therewith and a processor coupled to the computer-readable storage medium. Responsive to executing the computer-readable program code, the processor can be configured to perform executable operations. The operations can include receiving from an email sender a plurality of recipient identifiers corresponding to recipients to whom the email is to be sent and grouping the recipient identifiers into a plurality of groups. The operations further can include generating a respective version of the email for each of the groups of recipient identifiers, wherein each version of the email exclusively identifies as recipients recipient identifiers for a respective group of recipients, and sending each version of the email to the group of recipients for whom the version of the email is generated.

Another embodiment can include a computer program product. The computer program product can include computer-readable program code embodied therewith. The computer-readable program code can be configured to perform the various steps and/or functions disclosed within this specification.

### BRIEF DESCRIPTION OF THE SEVERAL VIEWS OF THE DRAWINGS

FIG. 1 depicts a system for sending mass emails in accordance with one embodiment of the present invention.

FIG. 2 depicts a view of a sender email client via which an email is composed in accordance with one embodiment of the present invention.

FIG. 3 depicts another view of the sender email client via which the email is composed in accordance with one embodiment of the present invention.

FIG. 4 depicts a view of a recipient email client via which the email is received in accordance with one embodiment of the present invention.

FIG. 5 depicts a view of the sender email client in accordance with one embodiment of the present invention.

FIG. 6 depicts an example of an email thread in accordance with one embodiment of the present invention.

FIG. 7 is a flow chart illustrating a method of sending mass emails in accordance with another embodiment of the present invention.

FIG. 8 is a block diagram illustrating system for sending mass emails in accordance with another embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments described herein relate to categorizing email recipients into logical groups when sending a mass email. As used herein, the term “mass email” is defined as an email sent to a plurality of recipients. When a mass email is sent, the plurality of recipients to whom the email is sent can be categorized into a plurality of groups. Specifically, each group can include email recipients who likely know one another. The determination of such can be based on past email history, social networking interactions, or the like. Accordingly, recipients of the email need not be identified to other recipients who are not members of the same group. In this regard, a certain level of privacy can be maintained among the email recipients.

Further, the recipients of the email can be provided an option to reply to all other recipients identified in the same groups. For example, if a first recipient is identified in a group comprising four other recipients, the first recipient can select a “reply to all” button, or a “reply to all people I know” button, to send the reply to the other four recipients. In one arrangement, the reply also can be sent to the original sender of the email. Thus, recipients of the original email who are not identified in first recipients group need not receive the reply. Accordingly, such other recipients need not be inundated with replies from people not known to the recipients.

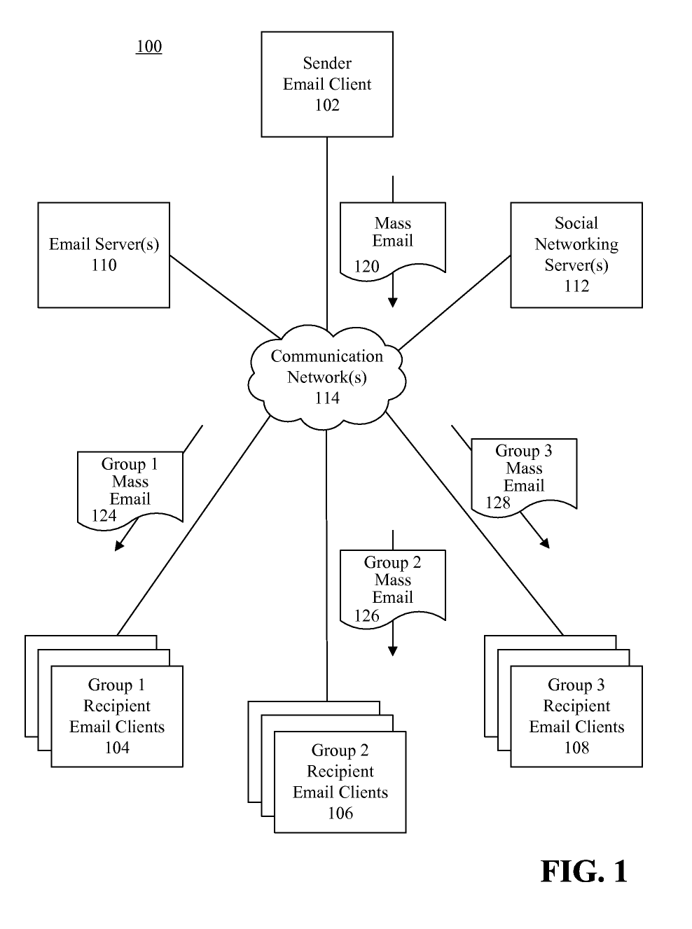

FIG. 1 depicts a system 100 for sending mass emails in accordance with one embodiment of the present invention. The system 100 can include an email client 102 used by a sender, and email clients for at least two groups of recipients. For example, the system 100 can include email clients 104 used by a first group of recipients, email clients 106 used by a second group of recipients, and email clients 106 used by a third group of recipients. Of course, any number of recipient groups can be defined and the invention is not limited to this example. In one embodiment, the sender and recipients can be people (i.e., human beings). In another embodiment, the sender can be an application that automatically generates emails. Further, one or more recipients can be applications that automatically process emails that are received.

The system further can include one or more email servers 110 and one or more social networking servers 112. The email server(s) 110 can be configured to accept, forward, deliver and store email messages. In one embodiment, at least one email server 110 can be configured to categorize recipients into a plurality of groups of recipients, as will be described herein. In another embodiment, the email client 102 can be configured to categorize recipients into a plurality of groups of recipients. The email server 110 and/or the email client 102 further can be configured to communicate with the social networking server(s) 112 to determine which recipients likely know one another, as will be described.

The email clients 102-110, the email server(s) 110 and the social networking server(s) 112 can be communicatively linked via one or more communication networks 114. The communication network(s) 114 can include the Internet, one or more WANs, one or more LANs, one or more wireless LANs, one or more cellular communication networks, and/or any other communication networks via which emails can be communicated.

In operation, via the email client 102, the sender can compose a mass email 120 (hereinafter “email”). In the email 120, the sender can identify recipients who are to receive the email 120. The recipients can be identified using the recipients' email addresses, user names, or any other identifiers suitable for identifying the recipients. In one embodiment, the sender can categorize the recipients into at least two groups of recipients. In another embodiment, the sender can identify the recipients, and the email client 102 can automatically categorize the recipients into at least two groups of recipients. In yet another embodiment, the sender can identify the recipients, and the email server 110 can automatically categorize the recipients into at least two groups of recipients.

In one aspect, to categorize the recipients, the email client 102 and/or the email server 110 can process past email exchanges involving two or more of the recipients to determine which recipients previously have communicated with each other, which can indicate that such recipients likely know one another. The email history can include emails previously sent and/or received by the sender. Such emails can be maintained by the email client 102 and/or the email server 110. A threshold value can be established to set a minimum level of previous communications involving recipients that must be met in order to assume the recipients likely know one another. For example, if two recipients previously received relatively few emails in which the recipients both were identified, an assumption can be made the recipients may not know each other, or may not know each other well, and thus not categorized into the same group of recipients. If however, the recipients both were sent the same emails a number of times at least equaling the threshold value, or the recipients replied to one another, an assumption that the recipients likely know each other can be made, and thus categorized into the same group of recipients.

A contact list maintained by the email client 102 and/or the email server 110 for the sender also can be analyzed to identify recipients likely who know one another. For example, contacts who share a common telephone number or a common address can be identified as likely knowing one another, and thus categorized into the same group of recipients. Further, contacts who are indicated as being family members also can be identified as likely knowing one another.

Further, the email history can include emails previously sent and/or received by one or more recipients, and such email history can be analyzed to categorize the recipients into a plurality of groups. Such emails can be maintained by the respective email clients 101-108 and/or the email server 110. Further, contact lists maintained by the email clients 104-108 and/or the email server(s) 110 for the recipients and such contact lists can be analyzed to categorize the recipients into a plurality of groups. In illustration, of one recipient is contained in another recipients contact list, a determination can be made that the recipients know one another, and thus can be added to the same recipient group.

In one aspect of the present invention, one or more of the recipients can be provided user selectable options (e.g., user settings) that indicate whether their email history and/or contact lists can be analyzed to perform the categorization described herein. In this regard, the email history and/or contact lists for recipients who have selected to have their email history/contact lists analyzed can be processed for the categorization, while the email history/contact lists for recipients who have not selected to have their email history analyzed can be ignored.

In yet another embodiment, the email client 102 and/or the email server 110 can query the social networking server(s) 112 to determine which recipients likely know one another based on social interactions on one or more social networking sites. In illustration, the email client 102 and/or the email server 110 can send to the social networking server(s) one or more queries which identify the recipients identified by the sender, and requests the social networking server(s) to respond with a message indicating groups of recipients who likely know one another. Such indication can be based on friend/contact relationships maintained in the social networking server(s) 112 for one or more social networking sites, historical information relating to communications exchanged on one or more social networking sites maintained by the social networking server(s) 112, or the like. A social networking site can be, for example, a website via which users socially interact.

In one aspect of the present invention, the social networking sites can provide user selectable options (e.g., privacy settings) that indicate whether their social networking information can be analyzed to perform the categorization described herein. Accordingly, the social networking information for recipients who have selected to have their social networking information analyzed can be processed for the categorization, while the social networking information for recipients who have not selected to have their social networking information analyzed can be ignored.

Regardless of the method used to categorize the email recipients, when the email 120 is sent, at least two versions of the email 120 can be generated. For example, a first version 124 of the email 120 can be generated for the first group of email recipients and sent to those recipients, a second version 126 of the email 120 can be generated for the second group of email recipients and sent to those recipients, and a third version 128 of the email 120 can be generated for the third group of email recipients and sent to those recipients.

Each version 124-128 of the email 120 can identify recipients included in a respective group, while excluding recipients identified in other groups. In the case that a particular recipient is identified in more than one recipient group, such recipient can be identified in each version 124-128 corresponding to the groups with which the recipient is associated. The recipients identified in the respective versions 124-128 of the email 120 can be identified in the “To” field of the respective versions 124-128, or identified in another suitable manner. The sender of the email 120 also can be identified in the respective versions 124-128 of the email 120, for example in a “From” field.

In one embodiment, the mass email 120 can be sent from the email client 102 to the email server 110, and the email server can generate the respective versions 124-128 of the email 120 and send the versions 124-128 to the respective groups of recipients. In another embodiment, the email client 102 can generate the respective versions 124-128 of the email 120 and send the versions 124-128 to the respective groups of recipients. Notwithstanding, the email client 102 can send the respective versions 124-128 via the email server(s) 110. The email clients 104 can receive the respective versions 124-128 of the email 120 in any suitable manner, for example by authenticating to their respective email servers 110 and downloading the versions 124-128 from such email servers 110.

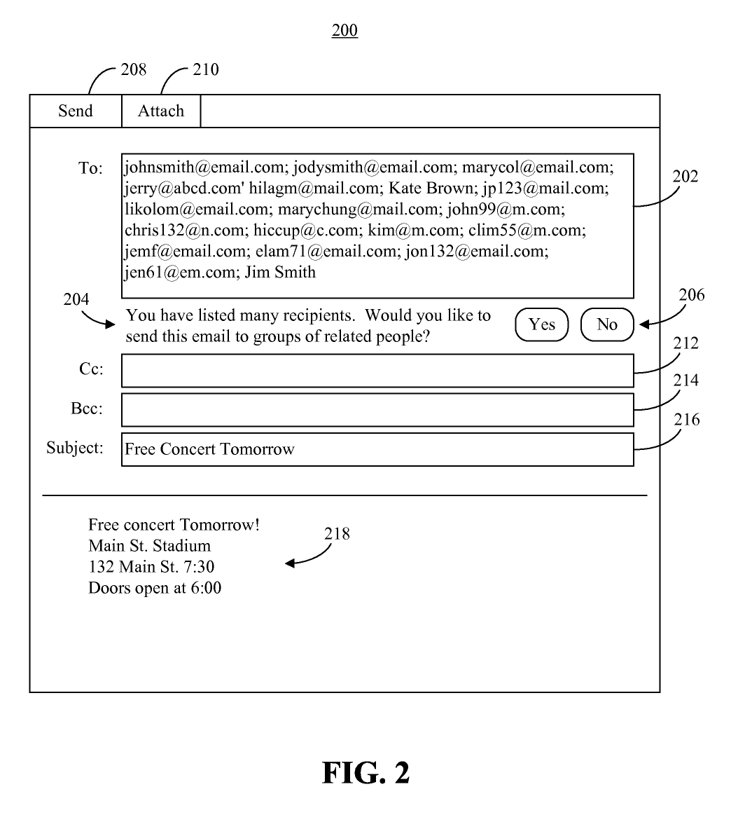

FIG. 2 depicts a view 200 of a sender email client via which an email is composed in accordance with one embodiment of the present invention. The view 200 can be presented as a window within the email client, or presented in another suitable manner. Within the view 200, an email sender can compose an email. In the “To” field 202, the sender can input identifiers corresponding to a plurality of recipients to whom the email is to be sent. If the number of recipients reaches a threshold value, the email client can prompt the sender to choose whether the sender wishes to divide the recipients into two or more groups. For example, a message 204 can be presented in the view 200 prompting the sender to indicate whether the sender desires to categorize the recipients into groups of recipients. In illustration, selectable user icons or buttons 206 can be presented in the view 200 from which the sender can select to either have the recipients of the email divided into a plurality of groups, and thus send multiple versions of the email in which each version identifies a group of recipients selected from all of the recipients, or to send the email in a conventional manner in which all recipients are identified in the email. When the sender chooses to categorize the recipients into a plurality of groups, the email server 110 and/or the email client 102 can perform such categorization, for example as previously described.

The view 200 also can include any of a myriad of user selectable fields, icons, buttons, etc. corresponding to the generation of emails. For example, the view 200 can include a selectable send icon or button 208 to send the email, a selectable attach icon or button 210 to attach one or more files to the email, a field 212 (e.g., “Cc”) to copy certain recipients on the email, a field 214 (e.g., “Bcc”) to blind copy recipients of the email, a field 216 indicating a subject of the email, etc. In addition, the view 200 can include content 218 of the email.

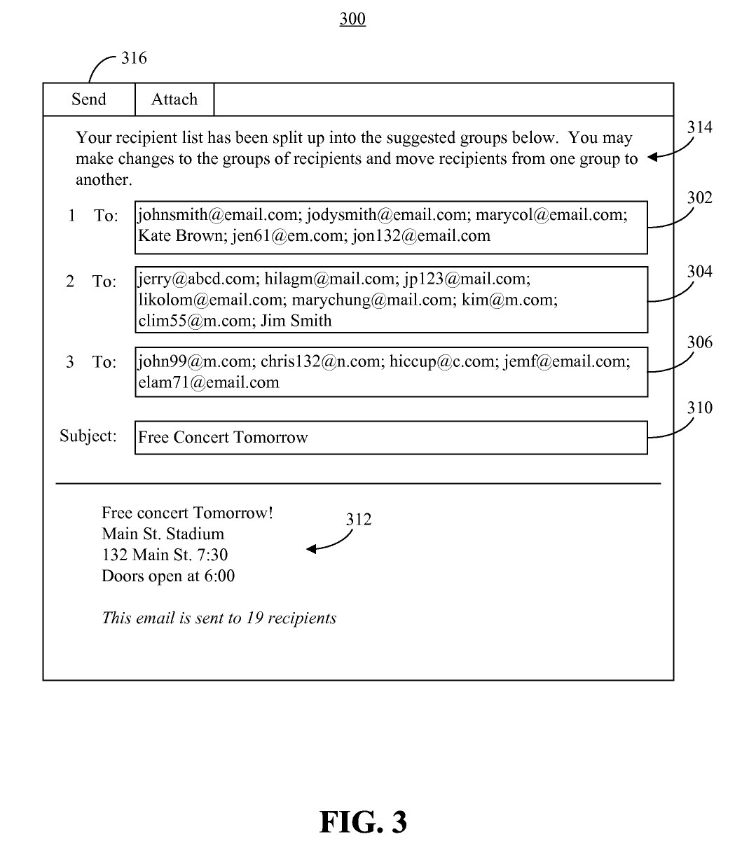

FIG. 3 depicts another view 300 of the sender email client via which the email is composed. The view 300 can be presented in response to the sender choosing to categorize the recipients into a plurality of groups. The view 300 can indicate the plurality of groups into which the recipients are categorized. In illustration, the view 300 can indicate identifiers for a first group 302 of recipients, identifiers for a second group 304 of recipients and identifiers for a third group 306 of recipients. Of course, fewer groups of recipients (e.g., two) can be identified, and more groups of recipients (e.g., four, five, six, seven, eight, nine, ten, etc.) can be identified. The view also can identify a subject 308 of the email and the subject of the email 310. In one embodiment, the content 312 can indicate the total number of recipients to whom the email is being sent, although the respective recipients need not see each of the recipients who are receiving the email.

Further, the view 300 can indicate to the user that the recipients have been categorized into groups (e.g., divided into groups). For example, a message 314 can be presented in the view 300 to indicate that the recipient list has been split up into suggested groups. The message 314 also can indicate to the sender that the sender may make changes to the groups of recipients and/or move recipients from one group to another. In this regard, the sender of the email can be provided an option to modify the groupings suggested in the view 300. For example, the sender can be provided an option to delete recipients from one or more groups of recipients 302-306, to add recipients to one or more groups of recipients 302-306, to copy and/or move one or more recipients from one group of recipients 302-306 to another, or the like. As noted, the recipients can be identified by corresponding identifiers.

Although not shown, the view 300 also can include a field indicating identifiers for recipients being copied on the email (e.g., in a “Cc” field) and/or identifiers for recipients being blind copied on the email (e.g., in a “Bcc” field). Still, the view 300 can include any of a myriad of other fields and/or messages that may be presented to a sender of an email and the invention is not limited in this regard. In response to the user selecting to send the email, for example by selecting the selectable send icon or button 316, a respective version of the email can be generated for each of the groups of recipients and sent to the respective groups of recipients.

As noted, each of the respective versions can indicate to the recipients other recipients included in their respective group. In illustration, a first version of the email can be sent to each of the recipients identified in the first group 302 that includes as recipients those recipients whose identifiers are included in the first group 302, a second version of the email can be sent to each of the recipients identified in the second group 304 that includes as recipients those recipients whose identifiers are included in the second group 304, and a third version of the email can be sent to each of the recipients identified in the third group 304 that includes as recipients those recipients whose identifiers are included in the third group 304.

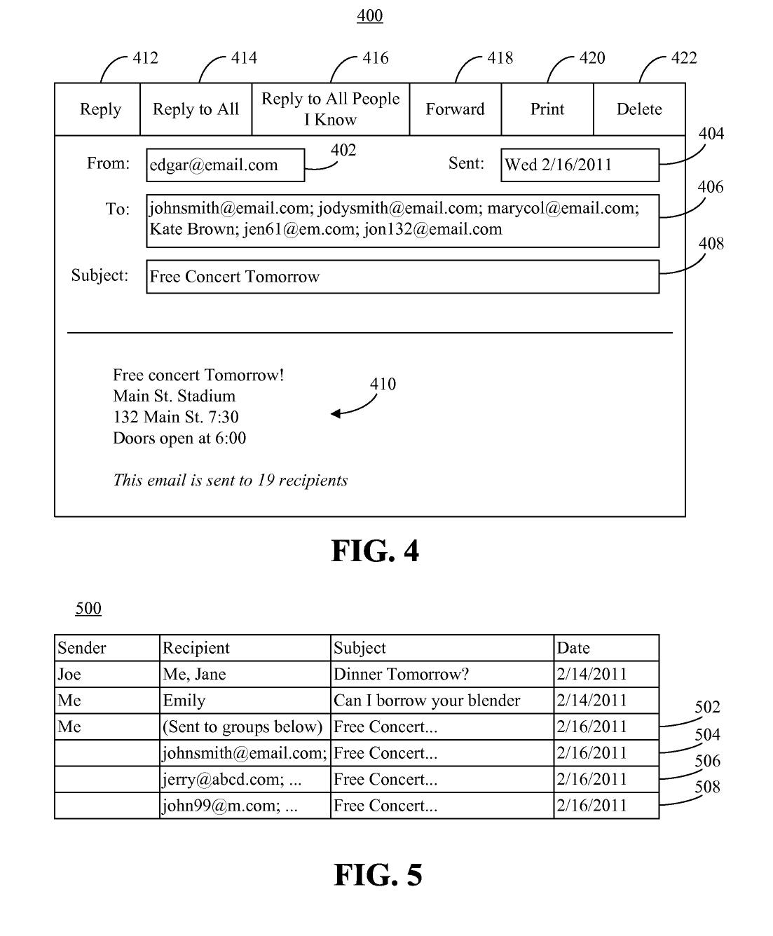

FIG. 4 depicts a view 400 of a recipient email client via which a version of the email is received in accordance with one embodiment of the present invention. The view 400 can include a field 402 that identifies an identifier for the sender of the email, a field 404 that identifies when the email was sent, a field 406 that presents identifiers for recipients included in the group of recipients to whom the particular version of the email was sent, a field 408 that identifies the subject of the email, and the content 410 of the email. Although not shown, the view 400 also can include a field presenting identifiers for recipients being copied on the email (e.g., in a “Cc” field). Still, the view 400 can include any of a myriad of other fields and/or messages that may be presented to a recipient of an email and the invention is not limited in this regard.

The version of the email can provide an indicator, such as a flag, that alerts the email client that the email being received is a version of the email being sent to the particular group of recipients. Thus, the email client can provide an indicator that indicates such circumstances. Moreover, the email client need only identify other recipients in the same group of recipients as the receivers of the email version. This need not be the case, however. For example, the version of the email can indicate as recipients only those recipients identified in the group to which the present recipient belongs, in which case the email client can be agnostic to the circumstance that other versions of the email are being sent to one or more other groups of email recipients. In such case, the content 410 of the email need not indicate the number of recipients receiving the email.

The recipient of the email can be provided an option to respond to the version of the email. For example, a “reply” selectable or icon or button 412 can be presented to allow the recipient to reply to the sender of the email with a reply to the email. A “reply to all” or “reply to all people I know” selectable icon or button 414 can be presented to allow the recipient to reply to other recipients in the same group of recipients in which the recipient is categorized, as well as the email sender, with a reply to the email. In this regard, the version of the email can indicate to the email client that the version of the email is a version of the email directed to a particular group of recipients. For example, the version of the email can provide an indicator, such as a flag, that alerts the email client that the email being received is a version being sent to the particular group of recipients. Thus, the email client can provide an indicator to the recipient of such circumstances.

In this case, the reply need only be sent to the sender of the email and to other recipients identified in the same group of recipients in which the recipient is identified. Accordingly, recipients of different versions of the email need not receive the reply, thus avoiding a circumstance in which the recipients of different versions of the email receive emails receive reply emails that may not be of interest to them.

The view also can include a button or icon 416 to forward the email to other people, a button or icon 418 to print the email, a button or icon 420 to delete the email, and/or any other buttons or icons suitable for processing received emails. When a recipient replies to the email, for example by selecting “reply,” “reply to all,” or “reply to all people I know,” the replies can be categorized in the email client of the sender and/or the email server in a suitable manner.

In illustration, FIG. 5 depicts a view 500 of the sender email client in accordance with one embodiment of the present invention. The view 500 can indicate emails sent and received by the sender. Moreover, the email client can indicate sent and received email belonging to a particular thread. For example, the email sender can send an email 502. One or more of the recipients the email can reply to the email, for example by selecting “Reply,” “Reply to All,” or “Reply to All People I Know.” The email server and/or the email client of the sender can indicate email sent 502 and one or more responses 504, 506, 508 to the email. The email responses 504-508 can be associated with the original email 502 by being depicted in the view 500 beneath the original email 502, or in another suitable manner. By grouping the original email 502 and the email responses 504-508 in a suitable manner, the sender of the original email 502, a thread representing associated emails 502-508 can be presented to the sender of the original email.

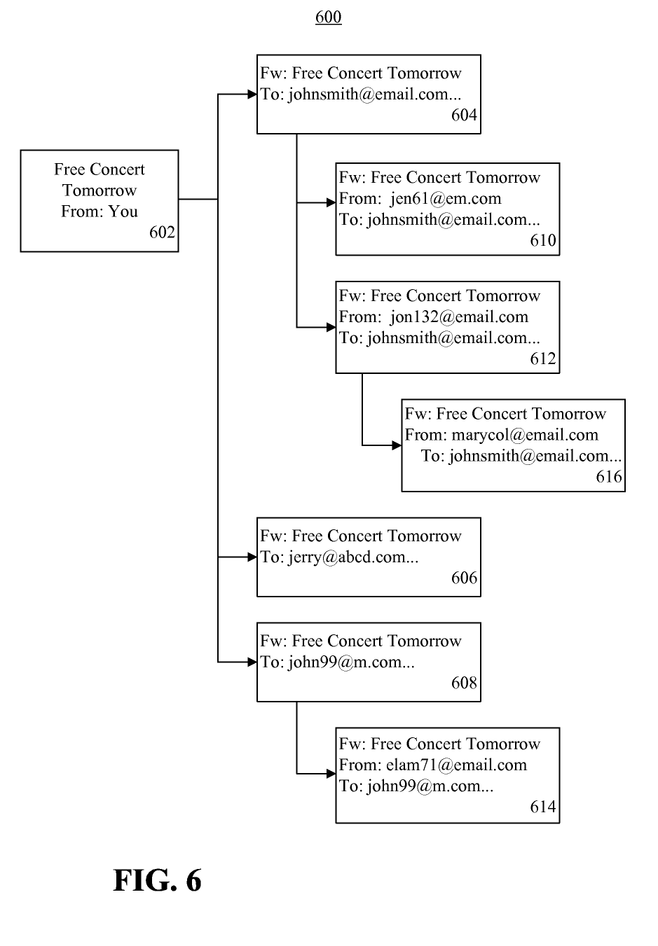

FIG. 6 depicts an example of an email thread 600 in accordance with one embodiment of the present invention. The email thread 600 can be presented to the original sender of the email 602 in any suitable manner, for example within the email client of the sender. In this regard, the email thread 600 can be represented in the view 500 of FIG. 5. The email thread 600 can include an original email 602, as well as versions 604, 606, 608 of the email 602 sent to the plurality of recipient groups. The email thread 600 also can include emails 610, 612, 614 sent in reply the versions 604-608 of the email 602, as well as replies, such as the email 616, sent in response to the emails 610-614. Any number of emails and replies can be generated, and the invention is not limited in this regard. The presentation of the email thread 600 can provide the original sender a way to track responses to the original email 602 that is sent.

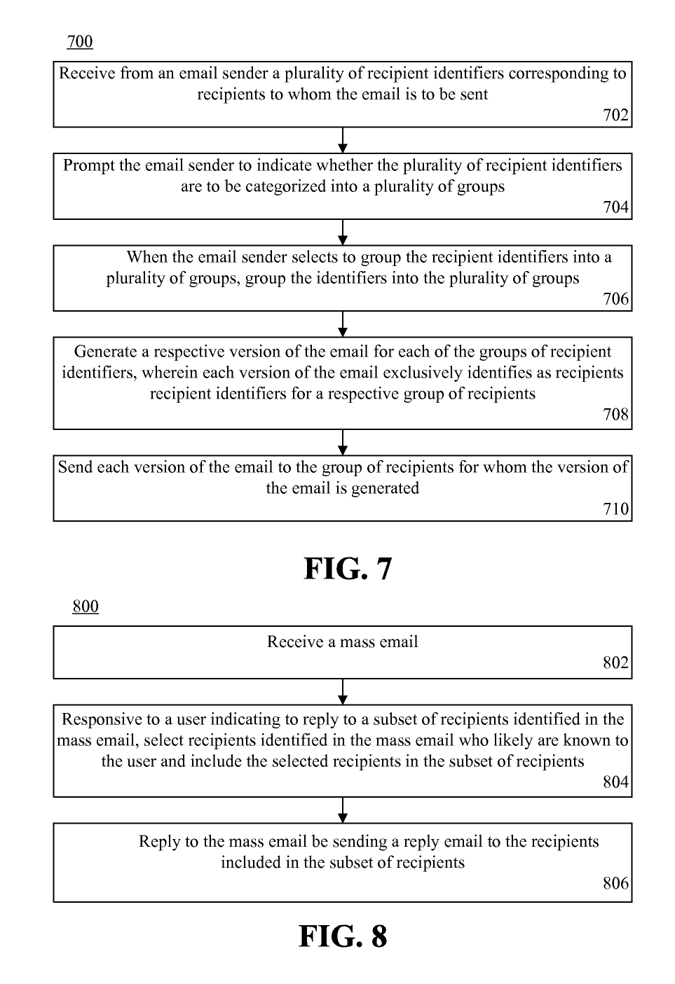

FIG. 7 is a flow chart illustrating a method 700 of sending mass emails in accordance with another embodiment of the present invention. At step 702, a plurality of recipient identifiers corresponding to recipients to whom the email is to be sent can be received from an email sender. At step 704 the email sender can be prompted to indicate whether the plurality of recipient identifiers are to be categorized into a plurality of groups. At step 706, when the email sender selects to group the recipient identifiers into a plurality of groups, the identifiers can be grouped into the plurality of groups. Grouping the recipient identifiers into the plurality of groups can include analyzing a list of the recipient identifiers to identify email recipients who likely know one another.

In one embodiment, analyzing the list of email recipients can include analyzing a history of emails sent to, or received from, the recipients. In another embodiment, analyzing the list of email recipients can include analyzing contact information corresponding to the recipients in a contact list. In another embodiment, analyzing the list of email recipients can include analyzing social contacts based on social networking interactions of the recipients on a social networking site. In yet another embodiment, analyzing the list of email recipients can include analyzing social contacts based on contact or friend relationships maintained on a social networking site.

At step 708, a respective version of the email for each of the groups of recipient identifiers can be generated, wherein each version of the email exclusively identifies as recipients recipient identifiers for a respective group of recipients. In each respective version of the email a list of recipient identifiers corresponding to the recipients to whom the version of the email is sent can be provided. The list of recipient identifiers can be processed by email clients of the recipients to provide an option for the recipients to send a reply to the email to other recipients identified in the group of recipients to whom the version of the email is sent. At step 710, each version of the email can be sent to the group of recipients for whom the version of the email is generated.

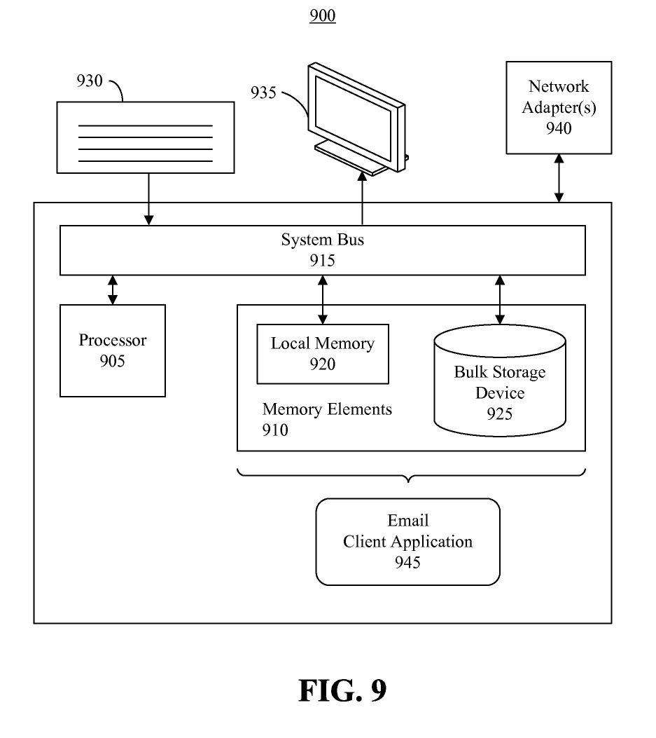

FIG. 8 is a block diagram illustrating system 800 for sending mass emails in accordance with another embodiment of the present invention. The system 800 can include at least one processor 805 coupled to memory elements 810 through a system bus 115. As such, the system 800 can store program code within the memory elements 810. The processor 805 can execute the program code accessed from memory elements 810 via the system bus 815. In one aspect, for example, the system 800 can be implemented as computer or other processing device that is suitable for storing and/or executing program code. It should be appreciated, however, that the system 800 can be implemented in the form of any system comprising a processor and memory that is capable of performing the functions described within this specification.

The memory elements 810 can include one or more physical memory devices such as, for example, local memory 820 and one or more bulk storage devices 825. Local memory 820 refers to random access memory or other non-persistent memory device(s) generally used during actual execution of the program code. Bulk storage device(s) 825 can be implemented as a hard disk drive (HDD), solid state drive (SSD) or other persistent data storage device. The system 800 also can include one or more cache memories (not shown) that provide temporary storage of at least some program code in order to reduce the number of times program code must be retrieved from the bulk storage device 825 during execution.

Input/output (I/O) devices such as a keyboard 830, a display 835, and a pointing device (not shown) optionally can be coupled to the system 800. The I/O devices can be coupled to the system 800 either directly or through intervening I/O controllers. One or more network adapters 840 also can be coupled to the system 800 to enable the system 800 to become coupled to other systems, computer systems, remote printers, and/or remote storage devices through intervening private or public networks. Modems, cable modems, and Ethernet cards are examples of different types of network adapters 840 that can be used with the system 800.

As pictured in FIG. 8, the memory elements 810 can store an email application 845. The email application 845, being implemented in the form of executable program code, can be executed by the system 800 to perform the methods and processes described herein for the sender email client.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of sending a mass electronic mail (email), the method comprising:
receiving from an email sender a plurality of recipient identifiers corresponding to recipients to whom the email is to be sent;
grouping the recipient identifiers into a plurality of groups;
generating a respective version of the email for each of the groups of recipient identifiers, wherein each version of the email exclusively identifies as recipients recipient identifiers for a respective group of recipients; and
sending each version of the email to the group of recipients for whom the version of the email is generated.

2. The method of claim 1, wherein grouping the recipient identifiers into the plurality of groups comprises analyzing a list of the recipient identifiers to identify email recipients who likely know one another.

3. The method of claim 2, wherein analyzing the list of email recipients comprises analyzing a history of emails sent to, or received from, the recipients.

4. The method of claim 2, wherein analyzing the list of email recipients comprises analyzing contact information corresponding to the recipients in a contact list.

5. The method of claim 2, wherein analyzing the list of email recipients comprises analyzing social contacts based on social networking interactions of the recipients on a social networking site.

6. The method of claim 2, wherein analyzing the list of email recipients comprises analyzing social contacts based on contact or friend relationships maintained on a social networking site.

7. The method of claim 1, further comprising:
prompting the email sender to indicate whether the plurality of recipient identifiers are to be categorized into a plurality of groups;
wherein grouping the recipient identifiers into the plurality of groups is performed in response to a selection by the email sender to group the recipient identifiers into at least two groups.

8. The method of claim 1, further comprising:
providing in each respective version of the email a list of recipient identifiers corresponding to the recipients to whom the version of the email is sent;
wherein the list of recipient identifiers is processed by email clients of the recipients to provide an option for the recipients to send a reply to the email to other recipients identified in the group of recipients to whom the version of the email is sent.

9. A system comprising:
a computer-readable storage medium having computer-readable program code embodied therewith; and
a processor coupled to the computer-readable storage medium, wherein responsive to executing the computer-readable program code, the processor is configured to perform executable operations comprising:
receiving from an email sender a plurality of recipient identifiers corresponding to recipients to whom the email is to be sent;
grouping the recipient identifiers into a plurality of groups;
generating a respective version of the email for each of the groups of recipient identifiers, wherein each version of the email exclusively identifies as recipients recipient identifiers for a respective group of recipients; and
sending each version of the email to the group of recipients for whom the version of the email is generated.

10. The system of claim 9, wherein grouping the recipient identifiers into the plurality of groups comprises analyzing a list of the recipient identifiers to identify email recipients who likely know one another.

11. The system of claim 10, wherein analyzing the list of email recipients comprises analyzing a history of emails sent to, or received from, the recipients.

12. The system of claim 10, wherein analyzing the list of email recipients comprises analyzing contact information corresponding to the recipients in a contact list.

13. The system of claim 10, wherein analyzing the list of email recipients comprises analyzing social contacts based on social networking interactions of the recipients on a social networking site.

14. The system of claim 10, wherein analyzing the list of email recipients comprises analyzing social contacts based on contact or friend relationships maintained on a social networking site.

15. The system of claim 9, wherein the processor further is configured to perform executable operations comprising:
prompting the email sender to indicate whether the plurality of recipient identifiers are to be categorized into a plurality of groups;
wherein grouping the recipient identifiers into the plurality of groups is performed in response to a selection by the email sender to group the recipient identifiers into at least two groups.

16. The system of claim 9, wherein the processor further is configured to perform executable operations comprising:
providing in each respective version of the email a list of recipient identifiers corresponding to the recipients to whom the version of the email is sent;
wherein the list of recipient identifiers is processed by email clients of the recipients to provide an option for the recipients to send a reply to the email to other recipients identified in the group of recipients to whom the version of the email is sent.

17. A computer program product comprising:
a computer-readable storage medium having computer-readable program code embodied therewith, the computer-readable program code comprising:
computer-readable program code configured to receive from an email sender a plurality of recipient identifiers corresponding to recipients to whom the email is to be sent;
computer-readable program code configured to group the recipient identifiers into a plurality of groups;
computer-readable program code configured to generate a respective version of the email for each of the groups of recipient identifiers, wherein each version of the email exclusively identifies as recipients recipient identifiers for a respective group of recipients; and
computer-readable program code configured to send each version of the email to the group of recipients for whom the version of the email is generated.

18. The computer program product of claim 17, wherein the computer-readable program code configured to group the recipient identifiers into the plurality of groups comprises computer-readable program code configured to analyze a list of the recipient identifiers to identify email recipients who likely know one another.

19. The computer program product of claim 18, wherein the computer-readable program code configured to analyze the list of email recipients comprises computer-readable program code configured to analyze a history of emails sent to, or received from, the recipients.

20. The computer program product of claim 18, wherein the computer-readable program code configured to analyze the list of email recipients comprises computer-readable program code configured to analyze contact information corresponding to the recipients in a contact list.

21. The computer program product of claim 18, wherein the computer-readable program code configured to analyze the list of email recipients comprises computer-readable program code configured to analyze social contacts based on social networking interactions of the recipients on a social networking site.

22. The computer program product of claim 18, wherein the computer-readable program code configured to analyze the list of email recipients comprises computer-readable program code configured to analyze social contacts based on contact or friend relationships maintained on a social networking site.

23. The computer program product of claim 17, the computer-readable program code further comprising:
computer-readable program code configured to prompt the email sender to indicate whether the plurality of recipient identifiers are to be categorized into a plurality of groups;
wherein grouping the recipient identifiers into the plurality of groups is performed in response to a selection by the email sender to group the recipient identifiers into at least two groups.

24. The computer program product of claim 17, the computer-readable program code further comprising:
computer-readable program code configured to provide in each respective version of the email a list of recipient identifiers corresponding to the recipients to whom the version of the email is sent;
wherein the list of recipient identifiers is processed by email clients of the recipients to provide an option for the recipients to send a reply to the email to other recipients identified in the group of recipients to whom the version of the email is sent.
